(19) United States
(12) Patent Application Publication
(10) Pub. No.: US 2005/0277010 A1
(43) Pub. Date: Dec. 15, 2005

(54) Controlled process gas pressure decay at shut-down

(76) Inventors: Gordon John Lamont, New Westminster (CA); Boyd Bethune King Thomson, Vancouver (CA)

Correspondence Address: BERESKIN AND PARR, 40 KING STREET WEST, BOX 401, TORONTO, ON, M5H 3Y2, CA

(21) Appl. No.: 11/017,735

(22) Filed: Dec. 22, 2004

Related U.S. Application Data
(60) Provisional application No. 60/530,924, filed on Dec. 22, 2003.

(51) Int. Cl. H01M 8/10

(52) U.S. Cl. 429/34

(57) ABSTRACT

A back pressure regulating device can be incorporated either into a fuel cell test station or into a fuel cell power module. For each of fuel can oxidant lines, it provides a gas pressure regulator. The pressure regulator is controlled by a pilot gas, supplied, preferably, through a pressure regulating valve and a three-way valve. Another port of the three-way valve provides a vent through a check valve and a needle or other flow control valve. The needle valve is connected to both check valves for the pilot gas lines for the fuel and oxidant. In normal operation, the pilot gas pressure, regulated by the pressure regulating valve, is supplied to the appropriate pressure regulator to control the respective fuel and oxidant gas pressures. On shut down or in case of power failure or the like, the three-way valve defaults to a condition in which it connects the pressure regulator through the respective check valve to the needle valve. This provides controlled decay of the pilot gas pressure supplied to the pressure regulator, and hence controlled decay of the pressures of the fuel and oxidant gases. The arrangement of two check valves connected to the needle valve maintains the fuel and oxidant gas pressures substantially equal, to prevent the occurrence of any large pressure differential, which could damage internal components of a fuel cell stack.

### FIELD OF THE INVENTION

The present invention relates to a system for controlling decay of gas pressures in a fuel cell stack at shut down. More particularly, the present invention relates to a fuel cell testing system having improved process gas pressure decay control at shut-down of the system.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode.

Simultaneously, an oxidant, such as oxygen or air is introduced to the second electrode where the oxidant reacts electrochemically in the presence of the electrolyte and a catalyst, producing anions and consuming the electrons circulated through the electrical circuit. The cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode.

The half-cell reactions at the first and second electrodes respectively are:
H₂ _{_{—}}2H⁺+2e⁻ (1)
½O₂+2H⁺+2e⁻_H₂O (2)

The external electrical circuit withdraws electrical current and thus receives electrical power from the fuel cell. The overall fuel cell reaction produces electrical energy as shown by the sum of the separate half-cell reactions shown in equations 1 and 2. Water and heat are typical by-products of the reaction.

In practice, fuel cells are not operated as single units. Rather, fuel cells are connected in series, either stacked one on top of the other or placed side by side. The series of fuel cells, referred to as a fuel cell stack, is normally enclosed in a housing. The fuel and oxidant are directed through manifolds in the housing to the electrodes. The fuel cell is cooled by either the reactants or a cooling medium. The fuel cell stack also comprises current collectors, cell-to-cell seals and insulation while the required piping and instrumentation are provided external to the fuel cell stack. The fuel cell stack, housing and associated hardware constitute a fuel cell module. In the present invention, the term “fuel cell” generally refers to a single fuel cell or a fuel cell stack consisting at least one fuel cell.

In order to test the performance of a fuel cell, a stand-alone fuel cell testing station is usually used. A fuel cell test station simulates operating conditions for the fuel cell stack being tested and monitors various parameters indicating the performance of the fuel cell. For example, a fuel cell testing station is usually capable of supplying reactants, e.g. hydrogen and air, and/or coolant, to the fuel cell with various temperature, pressure, flow rates and/or humidity. A fuel cell test station may also change the load of the fuel cell and hence change the voltage output and/or current of the fuel cell. A fuel cell test station monitors individual cell voltages within a fuel cell stack, current flowing through the fuel cell, current density, temperature, pressure or humidity at various points within the fuel cell. Such fuel cell test stations are commercially available from Hydrogenics Corporation in Mississauga, Ontario, Canada, or Greenlight Power Technologies in Burnaby, B.C, Canada, a subsidiary of Hydrogenics Corporation. There are also many other types of fuel cell test stations available from other test station manufacturers.

### SUMMARY OF THE INVENTION

In accordance with the present invention, there is provided a back pressure regulating device comprising:
a fuel gas back pressure regulator having an inlet and an outlet for fuel gas, and a pilot gas input;
a fuel gas regulated pilot gas supply;
a fuel gas check valve;
a fuel gas three-way valve, having a first port, a second port and a third port, the fuel gas three-way valve being connected by the first port thereof to the regulated pilot gas supply and by the third port thereof to the fuel gas back pressure regulator, and by the second port thereof to fuel gas check valve and operable, in a normal state, to provide fluid communication between the first and third ports, allowing fluid flow from the regulated pilot gas supply to the fuel gas back pressure regulator, and in a shut-down state, to provide fluid communication between the second and third ports, to allow fluid flow from the fuel gas back pressure regulator to the fuel gas check valve;
an oxidant gas back pressure regulator having an inlet and an outlet for oxidant gas, and a pilot gas input;
an oxidant regulated pilot gas supply;
an oxidant gas check valve;
an oxidant gas three-way valve, having a first port, a second port and a third port, the oxidant gas three-way valve being connected by the first port thereof to the oxidant regulated pilot gas supply, and by the third port thereof to the oxidant gas back pressure regulator, and by the second port thereof to the oxidant gas check valve, and operable, in a normal state, to provide fluid communication between the first and third ports, allowing fluid flow from the oxidant regulated pilot gas supply to the oxidant gas back pressure regulator, and in a shut-down state, to provide fluid communication between the second and third ports, to allow fluid flow from the oxidant gas back pressure regulator pilot gas input to the oxidant gas check valve; and
a flow control valve connected to both an outlet of the fuel gas check valve and an outlet of the oxidant gas check valve, the flow control valve venting to a vent, so that the flow control valve provides a desired pressure decay rate for the process gasses by allowing the pressure signal of the pilot gas to the fuel gas and oxidant back pressure regulators to decay in a controlled manner through the flow control valve.

Each of the fuel gas and oxidant three-way valves can include an electrical actuation device, such as a solenoid, or each of them can alternatively, or as well, be manually operable.

The back pressure regulating device preferably includes a control unit connected to the fuel gas and oxidant three-way valves and the fuel gas and oxidant pressure regulating valves.

The flow control valve can comprise a needle valve.

The back pressure regulating device can be used in combination with a fuel cell test station.

Alternatively, the back pressure regulating device can be provided in combination with a fuel cell power module including a fuel cell stack having inlets for fuel and oxidant gases and outlets connected to the inlet of the fuel gas back pressure regulator and the inlet of the oxidant back pressure regulator.

### BRIEF DESCRIPTION OF THE DRAWINGS

For a better understanding of the present invention and to show more clearly how it may be carried into effect, reference will now be made, by way of example, to the accompanying drawings which show a preferred embodiment of the present invention and in which:

FIG. 1 is a schematic view of a fuel cell stack with associated balance of plant, in accordance with the present invention

FIG. 2 is a schematic view of a back pressure control device in accordance with the present invention; and

FIG. 3 is a diagram showing the pressure decay characteristics of the system.

### DETAILED DESCRIPTION OF THE INVENTION

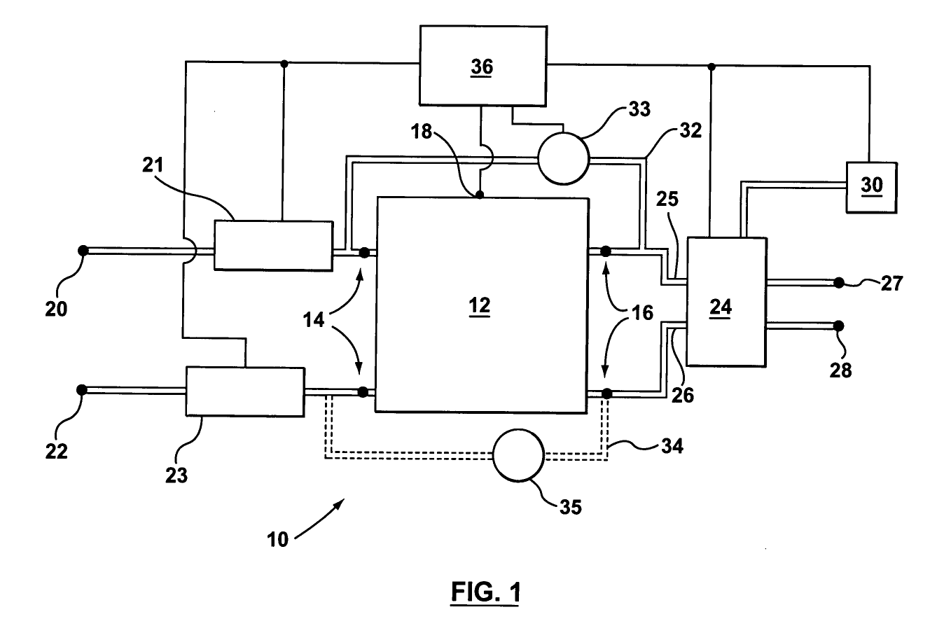

Referring first to FIG. 1, there is shown a schematic view of a fuel cell stack with associated balance of plant equipment, generally indicated by the reference 10. As is detailed below, the fuel cell stack could form part of a power module, or it could be a fuel cell stack that is being testing within a fuel cell test station. The actual fuel cell stack is indicated at 12.

As is known in this art, the fuel cell stack 12 is provided with necessary balance of plant components, to ensure complete operation of the stack. These are indicated schematically in FIG. 1, without attempting to show all details of known components necessary for operating a stack. As is known, it is necessary to control, for example, inlet and outlet pressures, temperatures and humidity of gases to the stack, coolant flow rates and the like. For example, fuel cell stacks are never one hundred percent efficient, so that it is usually necessary to provide some sort of cooling, which, commonly, can be natural, convective cooling, or forced cooling with some coolant medium pumped through the fuel cell stack; for simplicity no details of any cooling scheme are shown in FIG. 1.

Turning to the details of FIG. 1, the fuel cell stack 12 is provided with inlets 14 for fuel and oxidant gases and corresponding outlets 16 for exhausted fuel and oxidant gases. The inlets 14 are connected to a fuel inlet 20 via a fuel conditioning unit 21 and an oxidant inlet 22 via an oxidant conditioning unit 23.

Again, as is now known in this art, the fuel and oxidant conditioning units 21, 23 are provided to ensure that these gases are supplied to the stack 12 at appropriate conditions of pressure, humidity, temperature and flow rate. For this purpose, heaters and/or coolers, humidifiers, pumps and the like can be provided within the conditioning units 21, 23.

On the exhaust side of the stack 12, the outlets 12 are connected to a back pressure regulating device 24, in accordance with the present invention, having an inlet 25 for the fuel gas and an inlet 26 for the oxidant gas. As is detailed below, the back pressure regulating device 24 also has respective vents 27, 28 for fuel and oxidant gases. A pilot gas supply 30 is further connected to the regulating device 24.

As is known, it is often advantageous to provide for recirculation of at least one of the process gases or fuel cell stack. Here, a recirculation line 32 is shown including a pump 33, connecting the fuel outlet 16 to the fuel inlet 14 of the stack 12. Where a pure fuel, such as hydrogen, is used, recirculation can maintain desired flow rates of the gas through the stack 12, while only requiring makeup gas to be provided from the fuel input 20 (as detailed below, it is usually also necessary to occasionally vent the stack to prevent accumulation of contaminant and inlet gases within the fuel path through the stack 12).

For completeness, a corresponding recirculation line 34 and pump 35 are indicated in dotted lines for the oxidant side of the stack 12. Commonly, air is used as an oxidant, and as air comprises approximately eighty percent nitrogen, an inert gas that takes no part in the reactions in the fuel cell stack 12, there is no advantage in recirculation of the spent oxidant. For this reason, this possibility is simply indicated in dotted lines.

Again, indicated quite schematically, there is a control unit 36. Such a control unit 36 will typically be connected to various sensors and the like to receive input signals, and correspondingly it will have various outputs for regulating pumps, valves and other components of the stack 23 and its associated balance of plant. Here, the control unit 36 shown connected to the fuel and oxidant conditioning units 21, 23, to the pump 33 (and it would correspondingly be connected to the pump 35 when present), to the back pressure regulating device 24 and to the pilot air supply 30.

Now, in a common test situation, the fuel cell stack 12 would be provided by itself, i.e. with just the input and outlet ports 14, 16. All the remaining components, providing the necessary balance of plant to operate the stack 12, would be part of a fuel cell test station. As noted above, this would, usually, include a provision for supplying coolant to the stack 12, and also not shown, would include means for taking power from the stack 12, passing it through a load and monitoring power generated. On the other hand, in the case of a complete fuel cell power module, all of the components shown in FIG. 1 would be integrated within the power module. The intention is that the power module would include the necessary balance of plant for operation of the stack, so that inputs required to the power module are simpler. The power module would then require just a supply of the two process gases, at appropriate pressures and flow rates, and possibly, a coolant supply. Connections would also be provided for power generated by the power module.

In use, fuel gas are supplied to the fuel and oxidant inputs 20, 22, the pressure and other conditions of the fuel gas at the inputs 14 are controlled by the conditioning units 21, 23, but it would also be understood that to a considerable extent, input pressures will be dependent upon pressures at the output, flow rates, etc.

At the output or exhaust side, the back pressure regulating device 24 regulates the pressures of the two gases and also venting of the gases.

For the fuel gas, where this is a pure gas, this is commonly be run in a recirculation mode, with gas being recirculated through the line 22. Then, the regulation device 24 will typically maintain the vent 27 closed most of the time, although it can open as required, to ensure that excess pressures are not achieved. At the same time, to prevent accumulation of inert and contaminant gases, the vent 27 is usually open periodically, to prevent such buildup.

On the oxidant side, where air is used as the oxidant, there will usually be no recirculation line. Instead, the vent 28 will more or less be continuously open, to vent exhausted oxidant gas, commonly comprising nitrogen from the air with any residual oxygen, to atmosphere. Simultaneously, the regulating device 24 maintains the desired back pressure at the oxidant outlet of the stack 12.

In the event that a pure oxidant is used, then recirculation, etc. can be provided similarly for the fuel gas side of the stack 12.

Now, a problem arises in use if there is a requirement to shut down the fuel cell stack 12 quickly, more particularly if there is a requirement to shut down the fuel cell stack 12 due to a power failure. Where shut down can be carried out in a controlled fashion, without time constraints, it is a simple matter to ensure that gases are vented and pressures reduced in a controlled fashion.

For the fuel cell stack 12, where this comprises a PEM (proton exchange membrane) fuel cell stack, the actual membranes are quite thin and delicate. Accordingly, it is necessary to ensure that there is no substantial pressure differential across these membranes, or the membranes can be damaged or ruptured. With power present and shut down effected in a controlled fashion, this is not a problem.

However, either in a fuel cell test station or in a fuel cell power module or other situation employing a fuel cell, it is desirable to provide for controlled venting of the gases in the event or a sudden and unexpected interruption in the power supply. Necessarily, a requirement for such a scheme is that electrical power not be required to control the venting of the fuel cell stack 12.

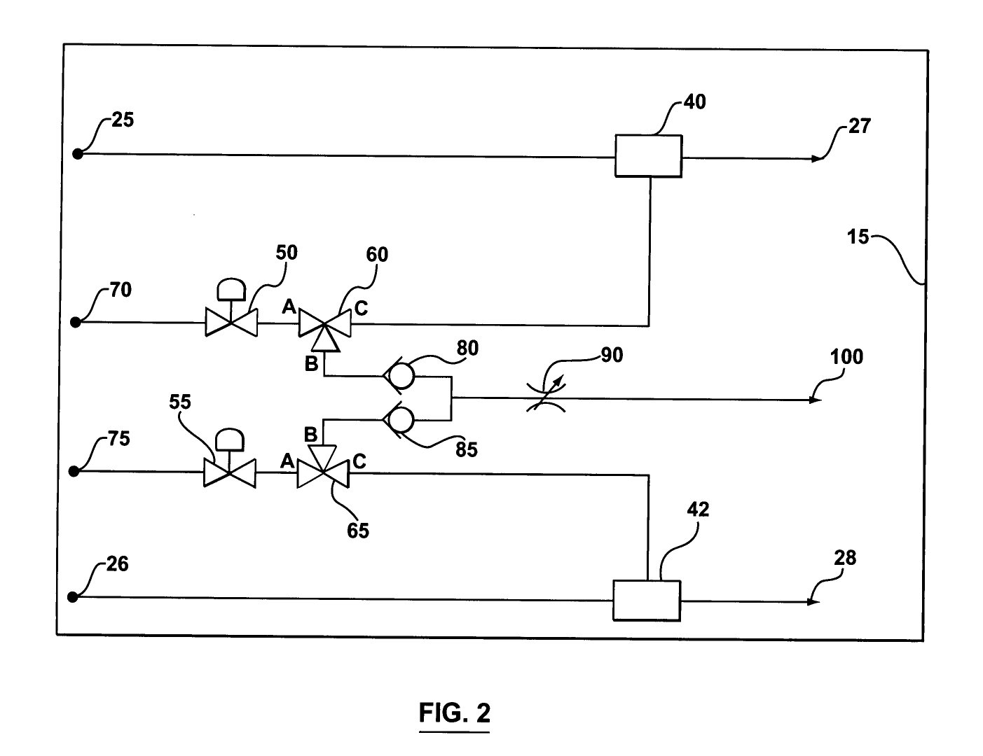

Referring to FIG. 2, the back pressure regulating device 24 is shown in detail. There are two separate process gas paths of the process gas controlled pressure decay system: one fuel gas path and one oxidant gas path.

The fuel gas path comprises a fuel gas back pressure regulator 40 connected to the fuel gas inlet 25. The fuel gas conduit allows fuel gas (typically hydrogen gas) to flow from the fuel cell stack 12 (FIG. 1) into the back pressure regulating device 24. The fuel gas is vented from the system through the fuel gas vent or exhaust 27. The fuel gas back pressure regulator 40 receives a set-point pressure value from a fuel gas pressure regulating valve 50. The fuel gas pressure regulating valve is fed from an air pilot supply line 70, and outputs a set-point pressure equal or lower to the pressure in the air pilot supply line. The set-point pressure value is set using an automatic control device (e.g. a connection to the control unit 36) or, alternatively, by hand manipulation of a manual fuel gas pressure regulating valve 50. A fuel gas three-way valve 60, for instance a solenoid valve, having a first port A, a second port B and a third port C, is connected between the fuel gas pressure regulating valve 50 and the fuel gas back pressure regulator 40. The three-way valve 60 normally connects ports B, C together, but, upon actuation of its solenoid, closes of the port B and connects ports A and C together. During normal operation of the back pressure regulating device 24, the solenoid of the fuel gas side three-way valve 60 is actuated to connect the first port A to the third port C, allowing gas flow from the fuel gas pressure regulating valve 50 to the fuel gas back pressure regulator 40. During a shut-down of or loss of power for the back pressure regulating device 24, the fuel gas three-way valve 60 assumes its normal state (power off state) in which the third port C is connected to the second port B, to allow gas to flow from the fuel gas back pressure regulator 40 to a fuel gas check valve 80. The fuel gas check valve 80 opens at a relatively low pressure to allow fluid flow to a common needle valve 90, which is set to allow the desired pressure decay rate for the process gas controlled pressure decay system 10.

The oxidant gas path corresponds to the fuel cell path, and comprises an oxidant gas back pressure regulator 42 connected to the oxidant gas inlet 26. The oxidant gas inlet 26 allows oxidant gas to flow from the fuel cell stack 12 (FIG. 1) into the back pressure regulating device 24. The oxidant gas is vented from the system through the oxidant gas vent 28. The oxidant gas back pressure regulator 42 receives a set-point pressure value from an oxidant gas pressure regulating valve 55. The oxidant gas pressure regulating valve is fed from an air pilot supply line 75 (which can be common with the air pilot supply line 70 and both are connected to the pilot air supply 30), and outputs a set-point pressure equal or lower to the pressure in the air pilot supply line. The set-point pressure value is set using an automatic control device (e.g. a connection to the control unit 36) or, alternatively, by hand manipulation of a manual oxidant gas pressure regulating valve 55. An oxidant gas three-way valve 65, for instance a solenoid valve, having a first port A, a second port B and a third port C, is connected between the oxidant gas pressure regulating valve 55 and the oxidant gas back pressure regulator 42. Like the three-way solenoid valve 60 on the fuel side, the solenoid valve 65 has a normal position in which ports B, C are connected together and port A is closed off; in operation with the solenoid actuated, ports A and C are connected together, with port B closed off. During normal operation of the back pressure regulating device 24, the oxidant gas three-way valve 65 is set to connect the first port A to the third port C, allowing gas flow from the oxidant gas pressure regulating valve 55 to the oxidant gas back pressure regulator 42. During a shut-down of or loss of power from the back pressure regulating device 24, the oxidant gas three-way valve 65 assumes its normal state (power off state) in which the third port C is connected to the second port B, to allow gas flow from the oxidant gas back pressure regulator 42 to an oxidant gas check valve 85. The oxidant gas check valve 85 opens at a relatively low pressure to allow gas flow to the common needle valve 90, and then to a vent or exhaust 100.

The valves 50, 55, 60, 65, 80, 85 and 90 form a process gas controlled pressure decay system. While the valve 90 is shown and described as a needle valve, it will be understood that any suitable flow control valve can be used that provides a throttling effect and provides controlled venting of the gases, controlled either in terms of, for example, rate of change of pressure or flow rate.

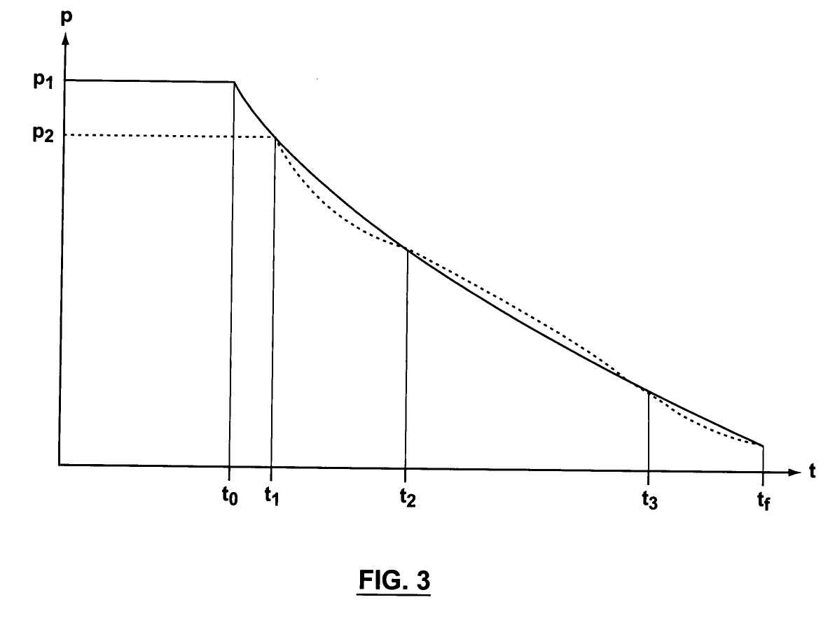

Operation of the device 24 and particularly the valves 80, 85 and 90 will now be described with reference to FIG. 3. Referring to FIG. 3, a diagram is shown where the pressure decay (p) over time (t) is illustrated with two curves: one solid line and one dashed line. The solid line typically depicts the pressure on the anode (fuel) side of the fuel cell stack 12, and the dashed line typically depicts the pressure on the cathode (oxidant) side of the fuel cell stack. In normal operation, the anode pressure is generally kept somewhat higher than the cathode pressure, to avoid oxidant gas leakage into the anode side and the resultant explosion risk. At the same time, the pressure differential is small enough, to be will within permissible pressure loadings on the membranes of the cells. The curves are to be seen as examples only, the actual pressure decay will vary depending upon the actual state of the process parameters at shut-down. The relative pressures of the anode and cathode sides may, of course, differ from what is shown as an example in FIG. 3.

One desired characteristic of the process gas controlled pressure decay system is to avoid large pressure differentials between the anode and cathode sides of the fuel cell 12 stack during shut down. This is advantageous because a large pressure differential might cause the membranes (not shown) of the individual fuel cells (not shown) of the fuel cell stack 12 to be deformed, which could cause permanent damage to the membranes, for example pin-holes that would cause leakage of process gas from one side of the membrane to the other.

In normal operation, the fuel gas check valve 80 and the oxidant gas check valve 85 are both closed since no over-pressure is present at the second ports B of the three-way valves 60 and 65, respectively. Also, no fluid communication exists between the second ports and the first or third ports (A and C, respectively). The process gas controlled pressure decay system according to the invention is then transparent to the fuel cell stack, or when present, the fuel cell testing system as a whole, in the sense that it is not noticed and has no influence on the operation of the stack.

On shut down of the fuel cell testing system, it is desirable to have a gentle pressure decay of the process gasses in the fuel cell stack, combined with a pressure decay that keeps the pressure on the anode side of the fuel cell stack substantially equal to the pressure on the cathode side. This is accomplished by the process gas controlled pressure decay system according to the invention by the interaction of the two check valves 80, 85, connected to the common needle valve 90. If one of the pressures at the fuel gas conduit 30 or the oxidant gas conduit 35 is higher than the other, as shown in FIG. 2 where p₁ is the higher pressure, for example the fuel gas pressure, the fuel gas side check valve 80 will open since the higher pressure p₁ is present at the fuel side check valve. This pressure is now also present at the outlet of the oxidant gas side check valve 85, which therefore remains closed (p₁ is at this time greater than p₂, which is present at the inlet of the oxidant gas side check valve). Thus, the greater pressure will bleed through the adjustable needle valve 90 and vent out through the vent 100, commencing at time t₀. As soon as the pressure at the anode side (in the example) has decreased to be equal to the pressure at the cathode side (starting at p₂), the oxidant gas side check valve 85 will also open to provide fluid communication to the needle valve 90 for the instrument air from the oxidant gas back pressure regulator 42, at time t₁.

Should the pressure at the cathode side decrease faster than the pressure at the anode side (as shown in the example), the oxidant gas side check valve will close because the situation would be similar to the situation described above immediately after shut-down, and the anode pressure would be allowed do decrease until it “catches up” to the cathode pressure again, when both check valves will open again, at time t₂. Similarly, should the pressure at the anode side decrease faster than the pressure at the cathode side, the fuel gas side check valve will close and the cathode pressure would be allowed do decrease until it “catches up” to the anode pressure again, when both check valves will open again, at time t₃. Should the pressure at the cathode side decrease faster than the pressure at the anode side (as shown in the example), the oxidant gas side check valve will close because the situation would be similar to the situation described above immediately after shut-down, and the anode pressure would be allowed do decrease until it “catches up” to the cathode pressure again, when both check valves will open again. The controlled gas pressure decay operation will end, at time t_{f}, when the pressure at either the anode or cathode side is too low to open either check valve. This pressure balancing, or equalizing, is thus the desired feature required to prevent an excessive pressure differential damaging cell membranes.

It should be further understood that various modifications can be made, by those skilled in the art, to the preferred embodiments described and illustrated herein, without departing from the present invention, the scope of which is defined in the appended claims. In particular, the present invention is applicable to any fuel cell, in form of a single cell, a cell stack, or a complete power module, having supplies of fuel and oxidant gases.

1. A back pressure regulating device comprising:
a fuel gas back pressure regulator having an inlet and an outlet for fuel gas, and a pilot gas input;
a fuel gas regulated pilot gas supply;
a fuel gas check valve;
a fuel gas three-way valve, having a first port, a second port and a third port, the fuel gas three-way valve being connected by the first port thereof to the regulated pilot gas supply and by the third port thereof to the fuel gas back pressure regulator, and by the second port thereof to fuel gas check valve and operable, in a normal state, to provide fluid communication between the first and third ports, allowing fluid flow from the regulated pilot gas supply to the fuel gas back pressure regulator, and in a shut-down state, to provide fluid communication between the second and third ports, to allow fluid flow from the fuel gas back pressure regulator to the fuel gas check valve;
an oxidant gas back pressure regulator having an inlet and an outlet for oxidant gas, and a pilot gas input;
an oxidant regulated pilot gas supply;
an oxidant gas check valve;
an oxidant gas three-way valve, having a first port, a second port and a third port, the oxidant gas three-way valve being connected by the first port thereof to the oxidant regulated pilot gas supply, and by the third port thereof to the oxidant gas back pressure regulator, and by the second port thereof to the oxidant gas check valve, and operable, in a normal state, to provide fluid communication between the first and third ports, allowing fluid flow from the oxidant regulated pilot gas supply to the oxidant gas back pressure regulator, and in a shut-down state, to provide fluid communication between the second and third ports, to allow fluid flow from the oxidant gas back pressure regulator pilot gas input to the oxidant gas check valve; and
a flow control valve connected to both an outlet of the fuel gas check valve and an outlet of the oxidant gas check valve, the flow control valve venting to a vent, so that the flow control valve provides a desired pressure decay rate for the process gasses by allowing the pressure signal of the pilot gas to the fuel gas and oxidant back pressure regulators to decay in a controlled manner through the flow control valve.

2. A back pressure regulating device as claimed in claim 1, wherein each of the fuel gas and oxidant three-way valves includes an electrical actuation device.

3. A back pressure regulating device as claimed in claim 1, wherein each of the fuel gas and oxidant pressure regulating valves is manually operable.

4. A back pressure regulating device as claimed in claim 2, wherein each of the fuel gas and oxidant back pressure regulating valves includes a solenoid actuation device.

5. A back pressure regulating device as claimed in claim 4, including a control unit connected to the fuel gas and oxidant three-way valves and the fuel gas and oxidant pressure regulating valves.

6. A back pressure regulating device as claimed in any one of the preceding claims, wherein the flow control valve comprises a needle valve.

7. A back pressure regulating device as claimed in any one of claims 1 to 5, wherein the fuel gas regulated pilot gas supply comprises an inlet for a pilot gas supply connected through a fuel gas pressure regulating valve, and wherein the oxidant regulated pilot gas supply comprises an inlet for a pilot gas supply connected through an oxidant pressure regulating valve

8. A back pressure regulating device as claimed in any one of claims 1 to 5, in combination with a fuel cell test station.

9. A back pressure regulating device as claimed in any one of claims 1 to 5, in combination with a fuel cell power module including a fuel cell stack having inlets for fuel and oxidant gases and outlets connected to the inlet of the fuel gas back pressure regulator and the inlet of the oxidant back pressure regulator.
